(19) United States
(12) Patent Application Publication
(10) Pub. No.: US 2016/0362033 A1
(43) Pub. Date: Dec. 15, 2016

(54) FLOOR-BOUND TRANSPORT VEHICLE FOR CONTAINERS, FEATURING A LIFTING FUNCTION

(71) Applicant: Terex MHPS IP Management GmbH, Dusseldorf (DE)

(72) Inventors: Mike Hegewald, Dusseldorf (DE); Jannis Moutsokapas, Monheim (DE); Armin Wieschemann, Oberhausen (DE)

(21) Appl. No.: 15/107,256

(22) PCT Filed: Dec. 11, 2014
(86) PCT No.: PCT/EP2014/077457

§ 371 Date: Jun. 22, 2016

(30) Foreign Application Priority Data
Dec. 23, 2013 (DE) 10 2013 114 841.7

(51) Int. Cl. B60P 1/02; B60P 1/64

(52) U.S. Cl. CPC B60P 1/027; B60P 1/6445

(57) ABSTRACT

A floor-bound transport vehicle for transporting containers has at least one lifting platform which is arranged on a vehicle frame of the transport vehicle and can be lifted from a lowered transportation position into a raised transfer position and lowered again via a lifting drive. The lifting drive is part of a vertically adjustable wheel suspension on a chassis of the transport vehicle. In order to be able more easily pick up and put down the containers, the wheel suspension is designed in the manner of a hinge.

### CROSS REFERENCE TO RELATED APPLICATION

The present application claims the priority benefits of International Patent Application No. PCT/EP2014/077457, filed on Dec. 11, 2014, and claims benefit of DE 10 2013 114 841.7, which are hereby incorporated herein by reference in their entireties.

### BACKGROUND OF THE INVENTION

The invention relates to a ground transport vehicle for the transportation of containers having at least one load surface disposed on a vehicle frame of the transport vehicle and able to be raised from a lowered transport position by a lifting drive to a raised transfer position or lowered reversely, wherein the lifting drive is part of a height-adjustable wheel suspension of a running gear of the transport vehicle.

From European patent document EP 0 302 569 B1 a system is already known for loading and unloading a ship with containers. This system comprises at least one quay crane for loading and unloading the container ships moored at the quay. Using the quay cranes, the containers are picked up from a transport vehicle or the containers are set down on this transport vehicle. This transport vehicle is able to travel on the quay without the use of rails and is guided automatically by a control device. The container is unloaded from the transport vehicle or picked up from the transport vehicle at a stationary transfer station. This transfer station consists essentially of stationary support tables onto which the containers are set down or from which the containers are picked up. These support tables are formed in the manner of a support arm and support the container from below in the region of their long sides. Accordingly, the space between the opposing support tables is narrower than the width of the containers. In order to be able to pick up the container from the support table or to set it down thereon, provision is made for the transport vehicle to have a platform for transportation of the containers, which platform is raised relative to a vehicle frame of the transport vehicle in order to receive a container and then the transport vehicle is driven out of the region of the support tables with the container now resting on the platform thereof. When using a platform which can be raised and lowered, the platform is to be lowered for onward travel of the transport vehicle. The setting down of the containers on the support table is effected in reverse order. In order that the transport vehicle is able to receive the containers from the transfer station, the platform which can be raised and lowered has a width which is narrower than the space between the opposing support tables. From this transfer station, the containers are then picked up by a gantry crane operating automatically and set down in a container storage depot or set down therein by the gantry crane.

Furthermore, in relation to the transport vehicle it is stated that the platform can be raised and lowered by a mechanical, pneumatic or hydraulic lifting drive.

DE 10 2007 039 778 A1 discloses a ground transport vehicle for the transportation of containers having at least one lifting platform disposed on a vehicle frame of the transport vehicle, which lifting platform can be raised from a lowered transport position by a lifting drive to a raised transfer position or conversely lowered from the one to the other. For this purpose, the lifting platform is fastened via at least one knee lever on the vehicle frame so that the lifting platform can be raised or lowered via the at least one knee lever, for which purpose the lifting drive acts on the at least one knee lever. The lifting platform for the lifting and lowering movement is guided on the transport vehicle.

### SUMMARY OF THE INVENTION

The present invention provides an automatically guided, rubber-tired ground vehicle, such as a so-called AGV (Automatic Guided Vehicle), which comprises improved pick-up and set-down of the loads, such as containers.

In accordance with an embodiment of the invention, in the case of a ground transport vehicle for the transportation of containers having at least one load surface which is disposed on a vehicle frame of the transport vehicle and can be raised from a lowered transport position by a lifting drive to a raised transfer position or lowered reversely, wherein the lifting drive is part of a height-adjustable wheel suspension of a running gear of the transport vehicle, improved pick-up and set-down of the containers is achieved in that the wheel suspension is formed in the manner of a hinged joint. In this way, a simple possibility is created of raising or lowering the load surface. By integration of the lifting drive into the running gear and the hinge-like formation of the wheel suspension thus provided, an even lower construction height in the region of the vehicle frame is also achieved. The container load surface can also be designed in a simpler manner since it is static. Only the entire vehicle frame is moved.

In a constructionally simple manner, provision is made for the wheel suspension to comprise a strut articulated on the vehicle frame and a rocker pivotably articulated on the strut via a horizontal lifting spindle.

Furthermore, provision is made in a constructionally simple manner for the lifting drive to be connected in an articulated manner at least to the rocker and preferably additionally to the strut.

In particular, the running gear is a multi-axle running gear having a plurality of wheel suspensions.

In a particular embodiment, each wheel suspension comprises a swing axle which is attached to a strut via a respective rocker, wherein an adjustable hydraulic cylinder is articulated between the rocker and the strut for the lifting motion. The strut is connected at one end to the vehicle frame and, by means of the arrangement of the rocker between the swing axle and the strut, the vehicle frame or the container load surface can be raised and lowered by means of the hydraulic cylinder for pick-up or set-down purposes.

For this reason, the rocker is articulated at one end on the swing axle and at the other end on the strut.

In order to permit steering (straight travel, travel on a curve, travel on an incline, backwards movement etc.) of the individual axles, the strut is articulated on the vehicle frame via a rotary bearing which can rotate about an approximately vertically oriented axis. In order to effect the steering movement, the strut can have an externally toothed centre pivot plate for rotation about the rotary bearing. Monitoring of the steering deflection can be effected via angle transmitters (e.g. potentiometers). Alternatively, the steering movement can be effected via hydraulic cylinders, of which the changes in length are monitored.

The strut is a profile part which is open on one side, has a substantially U-shaped cross-section and is narrowed from the vehicle frame towards the rocker. Therefore, a high level of rigidity can be achieved with low weight. In addition, the hydraulic cylinder can therefore be centrally articulated on the vehicle frame within the profile below the fastening point of the strut, which is advantageous with respect to the absorption of force.

When the strut is inclined in the longitudinal direction of the vehicle such that the swing axle is disposed approximately vertically below the fastening point of the strut on the rotary bearing when the rocker is oriented approximately horizontally, an advantageous absorption of weight by the tyres or swing axles can be achieved.

The lift of the hydraulic cylinder is preferably 600 mm.

The preferred field of application of the transport vehicle in accordance with the invention is in its use as a container transport vehicle for port facilities, in particular in the form of an AGV.

In the present case, the running gear is considered to be the entirety of all moveable parts of the vehicle which serve for connection to the travel lane. The running gear comprises wheels, the wheel suspension, the suspension system, shock absorbers, steering means and brakes. The wheel suspension is understood to be all components for moveable connection between the wheel/tire and the vehicle frame.

Further details of the invention will become clear from the following description of an exemplified embodiment with reference to the drawings.

### BRIEF DESCRIPTION OF THE DRAWINGS

FIG. 1 is a perspective view of an automatically guided vehicle in a transfer station,

FIG. 2 is a perspective view of a vehicle in accordance with FIG. 1 outside a transfer station,

FIG. 3 is a front view of FIG. 1 in which the vehicle frame of the vehicle is raised,

FIG. 4 is a view in accordance with FIG. 3 with the vehicle frame lowered and

FIG. 5 is a view of the height-adjustable wheel suspension on the vehicle frame.

### DESCRIPTION OF THE PREFERRED EMBODIMENTS

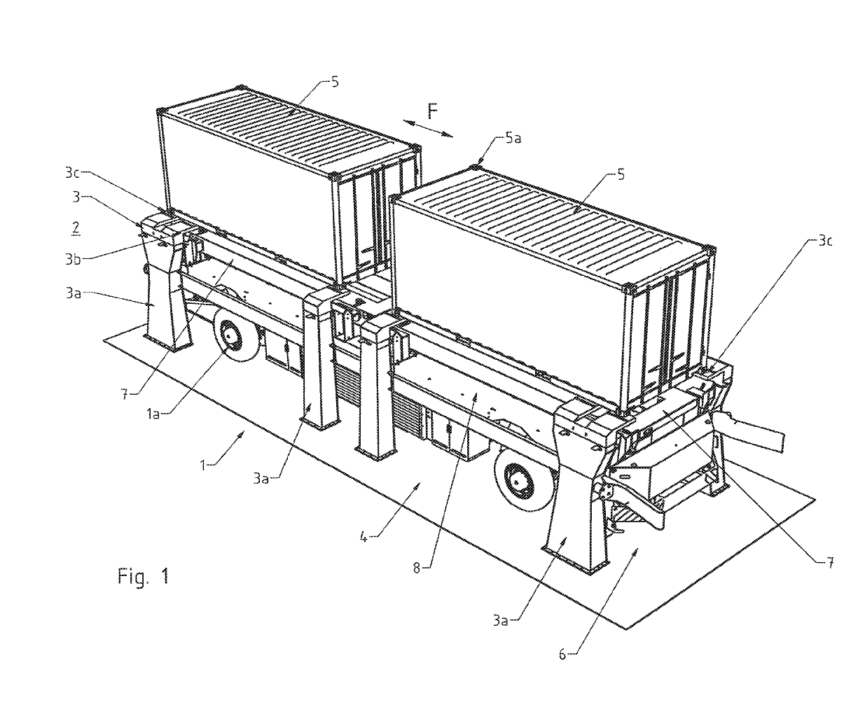

FIG. 1 shows a perspective view of an automatically guided vehicle 1 within a transfer station 2. The vehicle 1 can travel freely on the ground and not on rails but on tyres 1a in the sense of air-filled rubber tires. A transfer station of this type can serve as an interface between the automatically guided vehicles 1 and another transport means such as e.g. an automatic, semi-automatic or manual gantry crane with a spreader frame as the load pick-up means or a high-leg, manned or unmanned straddle carrier device.

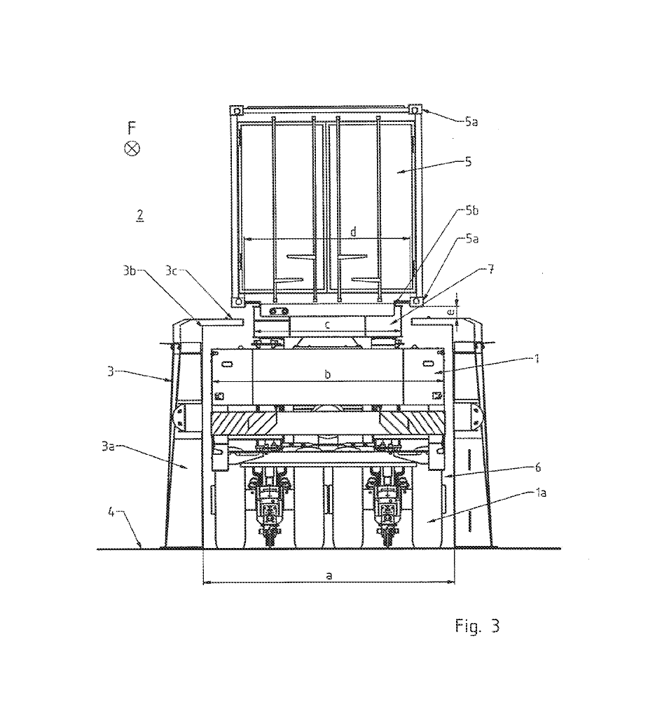

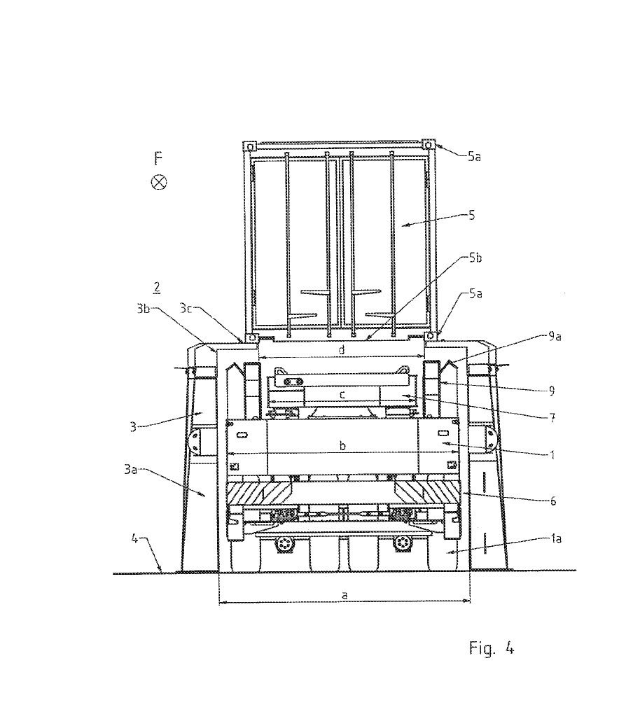

The transfer station 2 consists essentially of a stationary support frame 3 which has legs 3a in the form of vertical posts and horizontal support surfaces 3c fastened thereto to receive containers 5 to be set down thereon. The legs 3a rest at their lower end on ground 4 which, in a port area, is usually part of a quay. At the upper ends 3d thereof remote from the ground 4 the legs 3a are angled inwards and each form the horizontal support surface 3c so that the legs 3a appear L-shaped as seen in the direction of travel F of the vehicle 1. All in all, eight legs 3a are provided, of which in each case four legs adjoining an entry channel 6 for the vehicle 1 to the right and left as seen in the direction of travel F are disposed spaced apart from one another and from the vehicle 1 driven into the transfer station 2. The right and left legs 3a are also each disposed in an opposing arrangement. A space a (see FIGS. 3 and 4) between two oppositely disposed legs 3a is selected to be greater than the width b of the vehicle 1 in order to permit entry of the vehicle 1. In this connection, the space a is approximately 100 mm greater than the width b.

The containers 5 rest with their stable corner fittings 5a (corner castings), which are preferably disposed in their lower corners, on the support surfaces 3c when they have been set down thereon by the vehicle 1 or another transport means. Furthermore, the eight legs 3a or the associated support surfaces 3c are disposed with respect to one another such that 20-foot, 40-foot or 45-foot containers 5 can be set down with their corner fittings 5a on the support surfaces 3c. In FIG. 1, two 20-foot containers 5 have been set down one behind the other on the eight support surfaces 3c in the transfer station 2. In order to be able to set down 40-foot or 45-foot containers 5 in the transfer station 2, the first and last pairs of legs 3a, as seen in the direction of travel F, are wider in order to be able to receive, in the region of the upper ends 3b thereof, two support surfaces 3c which are spaced apart from one another and located one behind the other as seen in the direction of travel F. A total of ten support surfaces 3c are therefore provided. The outermost support surfaces 3c on the first and last pairs of legs 3a serve to receive a 45-foot container 5; the inner support surfaces 3c on the first and last pairs of legs 3a serve to receive a 40-foot container 5.

In the preferred exemplified embodiment described above, individual, flat and rectangular support surfaces 3c are disposed on the legs 3a. Instead of the individual support surfaces 3c, a support rail which is continuous as seen in the direction of travel F and has an L-shaped cross-section can also be used, wherein one limb is fastened to the upper end 3b of the legs 3a and the other limb forms the horizontal, inwardly facing support surface 3c.

In order to set down the containers 5 on the support surfaces 3c or in order to pick up the containers 5 from the support surfaces 3c, the vehicle 1 has a load surface 7 in the form of a box-like platform which is disposed on a vehicle frame 8 and can be vertically raised and lowered together with the vehicle frame 8 of the vehicle 1 by means of a running gear 10 of the vehicle 1. The lifting height of the load surface 7 or of the running gear 10 is about 600 mm. Furthermore, the load surface 7 extends, as seen in the direction of travel F of the vehicle 1, over almost the entire length of the vehicle 1 and is of a size appropriate for receiving two 20-foot containers 5 one behind the other or one 40-foot or one 45-foot container 5.

In FIG. 1, the vehicle 1 has just entered the transfer station 2. This is usually carried out automatically so that the entry channel 6 with the width a between the opposing legs 3a of the support frame 3 also only has to be slightly larger than the width b of the vehicle 1. Prior to entry of the vehicle 1 into the transfer station 2, the vehicle 2 was halted briefly in order to raise the load surface 7 jointly with the vehicle frame 8 from its lower transport position into its upper lifting position.

In this lifting position, the upper side of the load surface 7, on which the container 5 rests, protrudes, as seen in the vertical direction, over the support surfaces 3c which extend horizontally inwards. As seen in the direction of travel F, the load surface 7 has a narrower width c than the space d (see FIG. 4) between the support surfaces 3d of the opposing legs 3a of the support frame 3. Therefore, the vehicle 1 can enter the transfer station 2 with its load surface 7 raised in the lifting position, without the support platform 7 coming into contact with the support surfaces 3c. The upper side of the support platform 7 is also located above the support surfaces 3c so that when the vehicle 1 is entering the transfer station 2, the lower surface 5c (see FIG. 3) of the container 5, in particular the corner fittings 5a thereof, is located above the support surfaces 3c.

Furthermore, provision is made for guide elements 9, conventionally designated as container position adapters, which are disposed at the lateral edges, as seen in the direction of travel F, on the vehicle frame 8 and protrude vertically upwards, to be able to pivot inwards, fold away or to be sunk in order not to collide with the support surfaces 3c as the vehicle 1 is entering the transfer station 2. The guide elements 9 are therefore moved out of a structural clearance required for entry of the vehicle 1 into the transfer station 2. The guide elements 9 consist essentially of ramp-like guide surfaces 9a, preferably made of sheet metal, which, as seen in the lowering direction of the container 5, taper in the direction of the load surface 7 and which serve to align a container 5 set down on the load surface 7 with respect to the load surface 7 and therefore in the direction of travel F and transversely with respect thereto. Accordingly, the guide elements 9 are disposed in the region of the corners of the containers 5 to be set down, in order to permit guidance of the containers 5 in, and transversely with respect to, the direction of travel F. Furthermore, in the region of the transfer station 2, the guide elements 9 are pivoted into the vehicle frame 8 of the vehicle 1.

When the vehicle 1 has achieved its desired entry depth into the transfer station 2, the load surface 7 jointly with the vehicle frame 8 is lowered into its transport position and the container 5 is set down with its corner fittings on the support surfaces 3c. The vehicle 1 can then leave the transfer station 2 with the load surface 7 lowered or the vehicle frame 8 lowered, leaving the container 5 behind on the support frame 3.

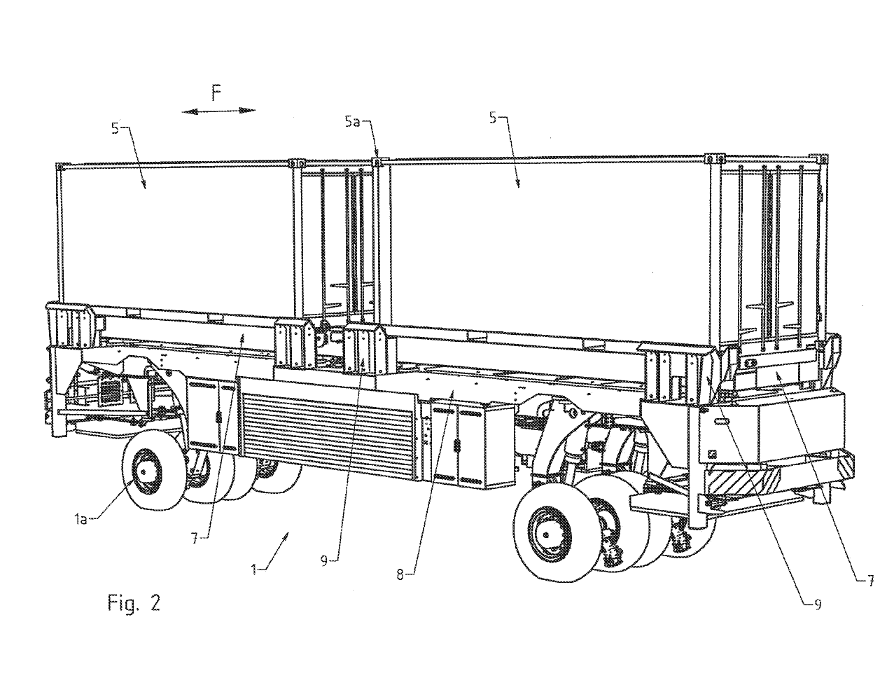

FIG. 2 shows a perspective view of a vehicle 1 in accordance with FIG. 1, in which, in order to illustrate the lifting function of the load surface 7, the vehicle frame 8 and the load surface 7 are shown in the raised lifting position.

In order to facilitate the setting down of the container 5 on the load surface 7 which is located for this purpose in the lower transport position, the above-described hopper-like guide elements 9 are provided on the vehicle frame 8 of the vehicle 1. These guide elements 9 have a guide surface 9a which is oriented inwardly towards the load surface 7 and which widen in the upwards direction starting from the vehicle frame 8.

FIGS. 1 and 2 also show that the vehicle 1 is not a rail vehicle but a vehicle 1 with air-filled rubber tyres 1a.

FIG. 3 shows a front view of FIG. 1 as seen in the direction of travel F of the vehicle 1 which is positioned in the transfer station 2 between the legs 3a. The container 5 which can be seen in this FIG. 3 and the load surface 7 with the vehicle frame 8 are located in the raised lifting position. It is clear that the corner fittings 5a or the lower surface 5b of the container 5 are located at a vertical distance e above the support surfaces 3c of the legs 3a. This space e can vary between 50 and 150 mm depending on the loading state of the container 5 and the filling pressure of the tyres 1a. It is also clear that two tyres 1a are provided per axle in the manner of a twin tyre arrangement.

FIG. 4 shows a view corresponding to FIG. 3, wherein, however, the load surface 7 with the vehicle frame 8 is located in its lowered transport position without supporting a container 5. The container 5 lies with its corner fittings 5a on the support surfaces 3c.

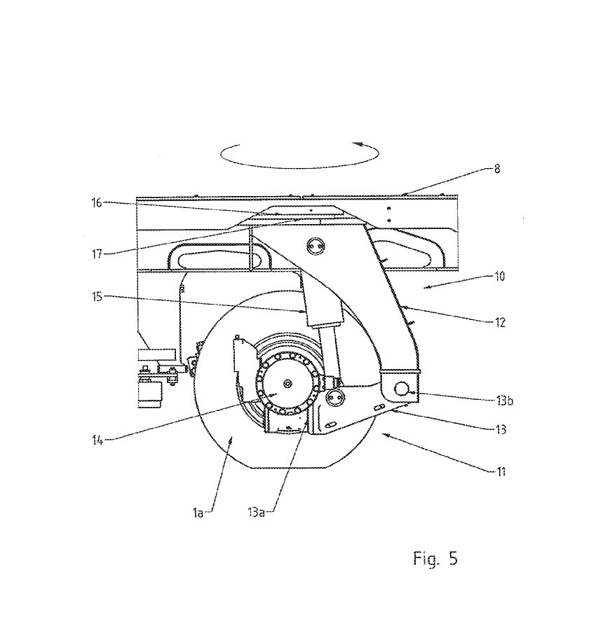

FIG. 5 shows a view of a height-adjustable wheel suspension 11 of the running gear 10 on the vehicle frame 8 of the vehicle 1. Each wheel suspension 11 comprises a swing axle 14 with two tyres 1a mounted thereon on the right and left—as seen in the direction of travel F—in the manner of a twin tyre arrangement. The swing axle is mounted on a first end 13a of a substantially horizontally extending rocker 13. By means of the rocker 13, which extends substantially in the direction of travel F, the swing axle 14 is attached in an articulated manner to a strut 12. The substantially horizontally extending rocker 13 is pivotably articulated on the strut 12 via a lifting spindle 13b extending substantially horizontally and transversely with respect to the direction of travel F. Between the strut 12 and the rocker 13 an approximate right angle is formed which varies depending on the lifting or lowering position of the vehicle frame 8 or the load surface 7. However, an angle is formed between the strut 12 and the rocker 13 in all positions. A lifting drive 15 in the form of a hydraulic cylinder 15 is articulated on an upper side of the rocker 13 in the region of the first end 13a adjacent to the swing axle 14 and is oppositely supported at an upper end of the strut 12. By means of the lifting drive 15, the vehicle frame 8 can be raised relative to the tyres 1a by extension of the lifting drive 15 and can be lowered by retraction of the lifting drive 15.

The lift of the lifting drive 15 is about 600 mm between the lowered and raised position of the vehicle frame 8 or the load surface 7. The lifting drive 15 thus presses e.g. the rocker 13 together with the swing axle 14 articulated thereon downwards during lifting of the support platform 7 with respect to the strut 12, whereby the strut 12 and rocker 13 move apart in the manner of a hinged joint and the vehicle frame 8 is raised accordingly.

The strut 12 is articulated on the vehicle frame 8 via a rotary bearing 16 which can rotate about an approximately vertically oriented axis, wherein the strut 12 has an externally toothed centre pivot plate 17 for rotation about the rotary bearing 16 in order to provide a steering function.

The strut 12 is a profile part which is open on one side, has a substantially U-shaped cross-section and tapers from the vehicle frame 8 towards the rocker 13. The strut 12 and the rocker 13 are thus dimensioned and disposed with respect to one another in such a way that, when the rocker 13 is oriented approximately horizontally, the swing axle 14 is disposed approximately vertically below the fastening point (or the middle thereof) of the strut 12 on the rotary bearing 16. Therefore, the rotary axis of the tyres 1a also lies almost vertically below the rotary bearing 16 when the running gear 10 is in the normal lowered transport position.

If is fundamentally also possible, with suitable lifting and transport apparatus, to set down the containers 5 outside the transfer station 2 onto the load surface 7 of the vehicle 1 or to pick it up from the load surface 7. The transfer station 2 advantageously assumes a buffer function with respect to the container 5.

### REFERENCE LIST

1 vehicle
1a tyre
2 transfer station
3 support frame
3a leg
3b upper end
3c support surface
4 ground
5 container
5a corner fitting
5b lower surface
6 entry channel
7 load surface
8 vehicle frame
9 guide element
9a guide surface
10 running gear
11 wheel suspension
12 strut
13 rocker
13a first end
13b lifting spindle
14 swing axle
15 lifting drive
16 rotary bearing
17 centre pivot plate
a space between opposing legs
b width of the vehicle
c width of the load surface
d space between opposing support surfaces
e space between support surface and lower surface
F direction of travel

1. A ground transport vehicle, for the transportation of containers comprising an automatically guided container transport vehicle for port facilities having at least one load surface disposed on a vehicle frame of the transport vehicle, wherein guide elements, are disposed at the lateral edges, as seen in the direction of travel, on the vehicle frame and serve to align a container to be set down on the load surface with respect to the load surface, wherein the load surface can be raised from a lowered transport position by a lifting drive to a raised transfer position or lowered reversely, wherein the lifting drive is part of a height-adjustable wheel suspension of a running gear of the transport vehicle, and the wheel suspension is formed in the manner of a hinged joint.

2. The transport vehicle as claimed in claim 1, wherein the wheel suspension comprises a strut articulated on the vehicle frame and a rocker pivotably articulated on the strut via a horizontal lifting spindle.

3. The transport vehicle as claimed in claim 2, wherein the lifting drive is connected in an articulated manner to the rocker.

4. The transport vehicle as claimed in claim 1, wherein the running gear is a multi-axle running gear and has a plurality of wheel suspensions.

5. The transport vehicle as claimed in claim 1, wherein the wheel suspension comprises a swing axle which is attached to a strut via a rocker, wherein the lifting drive is formed as a hydraulic cylinder between the rocker and the strut.

6. The transport vehicle as claimed in claim 5, wherein the rocker is articulated at one end on the swing axle and at the other end on the strut via a lifting spindle.

7. The transport vehicle as claimed in claim 2, wherein the strut is articulated on the vehicle frame via a rotary bearing which can rotate about an approximately vertically oriented axis.

8. The transport vehicle as claimed in claim 7, wherein the strut has an externally toothed centre pivot plate for rotation about the rotary bearing.

9. The transport vehicle as claimed in claim 2, wherein the strut is a profile part which is open on one side, has a substantially U-shaped cross-section and is narrowed from the vehicle frame towards the rocker.

10. The transport vehicle as claimed in claim 5, wherein the strut is inclined in the longitudinal direction of the vehicle such that the swing axle is disposed approximately vertically below the fastening point of the strut on the rotary bearing when the rocker is oriented approximately horizontally.

11. The transport vehicle as claimed in claim 1, wherein the lift of the lifting drive is approximately 600 mm.

12. (canceled)

13. The transport vehicle as claimed in claim 3, wherein the lifting device is additionally connected to the strut.

14. The transport vehicle as claimed in claim 13, wherein the running gear is a multi-axle running gear and has a plurality of wheel suspensions.

15. The transport vehicle as claimed in claim 14, wherein each wheel suspension comprises a swing axle which is attached to a strut via a respective rocker, wherein the lifting drive is formed as a hydraulic cylinder between the rocker and the strut.

16. The transport vehicle as claimed in claim 15, wherein the rocker is articulated at one end on the swing axle and at the other end on the strut via a lifting spindle.

17. The transport vehicle as claimed in claim 16, wherein the strut is articulated on the vehicle frame via a rotary bearing which can rotate about an approximately vertically oriented axis.

18. The transport vehicle as claimed in claim 17, wherein the strut has an externally toothed centre pivot plate for rotation about the rotary bearing.

19. The transport vehicle as claimed in claim 13, wherein the strut is articulated on the vehicle frame via a rotary bearing which can rotate about an approximately vertically oriented axis.

20. The transport vehicle as claimed in claim 4, wherein each wheel suspension comprises a swing axle which is attached to a strut via a respective rocker, wherein the lifting drive is formed as a hydraulic cylinder between the rocker and the strut.

21. The transport vehicle as claimed in claim 19, wherein the rocker is articulated at one end on the swing axle and at the other end on the strut via a lifting spindle.

22. The transport vehicle as claimed in claim 1, wherein the guide elements comprise container position adapters.

23. A system for transferring containers between a ground transport vehicle for containers and a transfer station for containers, wherein the transport vehicle for the transportation of containers comprises an automatically guided container transport vehicle for port facilities having at least one load surface disposed on a vehicle frame of the transport vehicle, which load surface can be raised from a lowered transport position by a lifting drive to a raised transfer position or lowered reversely, and wherein the transport vehicle with its raised or lowered load surface can enter the transfer station in order to transfer a container to the transfer station or to pick it up therefrom, wherein guide elements comprising container position adapters are disposed at the lateral edges, as seen in the direction of travel, on the vehicle frame and serve to align a container to be set down on the load surface with respect to the load surface, wherein the lifting drive is part of a height-adjustable wheel suspension of a running gear of the transport vehicle, and the wheel suspension is formed in the manner of a hinged joint.
